(19) United States
(12) Patent Application Publication
(10) Pub. No.: US 2008/0293153 A1
(43) Pub. Date: Nov. 27, 2008

(54) Photolabile System with Instantaneous Fluorescence Reporting Function

(76) Inventors: Andrei G. Kutateladze, Centennial, CO (US); Alexei Kurchan, Piscataway, NJ (US); Rudresha Kottani, Tucson, AZ (US); Janaki Majjigapu, Menomonee, WI (US)

Correspondence Address: GREENLEE WINNER AND SULLIVAN P C, 4875 PEARL EAST CIRCLE, SUITE 200, BOULDER, CO, 80301, US

(21) Appl. No.: 11/994,686

(22) PCT Filed: Jun. 30, 2006
(86) PCT No.: PCT/US06/25812

§ 371 Date: Jun. 6, 2008

Related U.S. Application Data
(60) Provisional application No. 60/697,760, filed on Jul. 8, 2005.

(51) Int. Cl. G01N 21/76

(52) U.S. Cl. 436/166; 436/172

(57) ABSTRACT

A method of photofragmentation is provided comprising: providing a masked fluorescent molecule having a masking group bonded to a fluorescent molecule through a photolabile covalent bond; exposing the masked fluorescent molecule to cleaving photoradiation, producing an unmasked fluorescent molecule; detecting the fluorescence of the unmasked fluorescent molecule. The photolabile covalent bond disrupts the conjugation of the fluorescent molecule, causing the fluorescence to be masked. When the photolabile covalent bond is broken, the conjugation is restored, resulting in an increase in fluorescence of the fluorescent molecule as compared to the masked fluorescent molecule.

### STATEMENT REGARDING FEDERALLY SPONSORED RESEARCH OR DEVELOPMENT

This invention was made, at least in part, with funding from the National Science Foundation under contract CHE-314344 and from the National Institutes of Health under contract GM067655. Accordingly, the U.S. government may have certain rights in this invention.

### BACKGROUND OF THE INVENTION

Fluorescent molecules are widely used in chemistry and biochemistry. Fluorophores are used to tag various molecular objects for detection in a number of assays, providing a sensitive means to follow molecular distributions and interactions, especially in the biologically-relevant context. Most of the existing assays use static tagging of a species of interest with a fluorophore, allowing for detection of the species of interest, and visualization with fluorescence microscopy. Static tagging with a fluorophore that is always “on” is suitable for many biological processes exhibiting slow molecular dynamics. In cases when molecular dynamics are fast, one approach is to create an instantaneous local concentration of, for example, a biological effector via photoinduced release with a pulsed source of light. There are several photochemically labile groups available to carry out such an instantaneous release [reviewed in: Dynamic studies in biology. M. Goeldner, R. Givens, Eds., Wiley-VCH, 2005]. These photolabile groups, however, are lacking the fluorescence reporting function. It is critical in many fields not only to be able to release molecules of interest instantaneously, but at the same time be able to observe, quantify and follow the spatial distribution, localization and/or depletion of the released molecular objects. Two approaches are found in the literature, which attempt to combine the functionality of photolabile protecting groups with benefits of fluorescent labeling. One approach is to tether a fluorophore to a quencher through a photolabile linker. In this approach, most of the fluorescence of the tethered fluorophore is quenched. Photoinduced fragmentation in the photolabile linker separates the fluorophore and the quencher and fluorescence recovers. Examples of the quenching approach are described in: Veldhuyzen, W. F.; Nguyen, Q.; McMaster, G.; Lawrence, D. S. J. Am. Chem. Soc. 2003, 125, 13358; Vazquez, M. E.; Nitz, M.; Stehn, J.; Yaffe, M. B.; Imperiali, B. ibid., 2003, 125, 10150; Pellois, J.-P.; Hahn, M. E.; Muir, T. W. J. Am. Chem. Soc. 2004, 126, 7170. A second approach is to “cage” a peripheral hydroxy group of a generic fluorophore (for example, phenolic group of fluoresceine) with a generic photolabile group such as an o-nitrobenzyl. Examples of the caging of an existing fluorophore with existing photolabile groups are described in: Krafft, G. A.; Sutton, W. R.; Cummings, R. T. J. Am. Chem. Soc. 1988, 110, 301; Zhao, Y.; Zheng, Q.; Dakin, K.; Xu, K.; Martinez, M.; Li, W.-H. J. Am. Chem. Soc. 2004, 126, 4653. Such caging normally reduces fluorescence intensity of the fluorophore, however, the UV-Vis absorption of the caged fluorophore is often higher than the photoremovable group, which inevitably reduces the quantum efficiency of release and may cause other complications. The same problems apply to the approaches based on fluorescence quenching—even thought the fluorescence is quenched, the fluorophore is still absorbing photons to a much greater extent than the photolabile linker.

An improved system to quantify and image molecules of interest is needed.

### SUMMARY OF THE INVENTION

A method of photofragmentation is provided comprising: providing a masked fluorescent molecule having a masking group bonded to a fluorescent molecule through a photolabile covalent bond which disrupts the conjugation of the fluorescent molecule; exposing the masked fluorescent molecule to cleaving photoradiation, producing an unmasked fluorescent molecule; detecting the fluorescence of the unmasked fluorescent molecule. In embodiments of the invention, either the unmasked fluorescent molecule or the masking group, or both, are attached to a molecule of interest. The molecule of interest is any molecule or structure which is able to be attached to either the unmasked fluorescent molecule or masking group, with any desired or required linkages between the molecule of interest and the unmasked fluorescent molecule or masking group. In one embodiment, the molecule of interest is a biological effector. In one embodiment, either the unmasked fluorescent molecule or the masking group, or both, are attached to a support. Examples of supports are dendrimers, particles including nanoparticles (having average size of below about 10⁻⁸ meters) and microparticles (having average size below about 10⁻⁶ meters), surfaces or liposomes. In one embodiment, the unmasked fluorescent molecule bonds to the masking group through a carbonyl group or a double bond. The photolabile covalent bond disrupts the conjugation of the fluorescent molecule, causing the fluorescence to be masked. When the photolabile covalent bond is broken, the conjugation is restored, resulting in an increase in fluorescence of the fluorescent molecule as compared to the masked fluorescent molecule.

Also provided is a photolabile molecule of formula: F-M, wherein F is a latent fluorescent molecule; M is a masking group which is bonded to the latent fluorescent molecule through a photolabile covalent bond which disrupts the conjugation of the fluorescent molecule. As discussed above, either F or M or both can be attached to a molecule of interest and/or a support.

Also provided is a plurality of photolabile molecules attached to a support. In this embodiment, a library of photolabile molecules can be formed. Also provided is a method of forming a plurality of support bound photolabile molecules, each molecule occupying a separate predefined region of the support, comprising: (a) binding a photolabile molecule to a first region of the support; (b) repeating step (a) on other predefined regions of the support, whereby each of the other regions has bound thereto another photolabile molecule, and wherein each other molecule may be the same or different from that used in step (a). This method may further comprise: (c) exposing the photolabile molecule(s) to cleaving photoradiation, producing unmasked fluorescent molecule(s); (d) detecting the fluorescence of the unmasked fluorescent molecule(s). In this embodiment, the photolabile molecule comprises the structure described above.

As used herein, “masking group” is a group, which when bound to a fluorescent molecule creating a masked fluorescent molecule, causes the masked fluorescent molecule to be non-fluorescent or have lower fluorescence intensity than the non-masked fluorescent molecule by disrupting the conjugation of the fluorescent molecule. Examples of masking groups include: dithiane, trithiane, dithiazine, tert-alkyl including tertiary butyl, carbonitriles, α-carbonyl, carboxamides, and other groups that are good radical leaving groups, as known in the art. As used herein, “photolabile covalent bond” is a covalent bond which can be broken by exposure to cleaving photoradiation. As used herein, “cleaving photoradiation” is light having the appropriate energy (wavelength) to break a photolabile covalent bond, as known in the art. One method of determining an appropriate wavelength of cleaving photoradiation is by measuring the absorbance spectrum of the masked fluorescent molecule, as known in the art. Examples of cleaving photoradiation include wavelengths in the ultraviolet spectrum, visible and infrared spectrum (between about 180 nm and 1.5 μm, for example) and all individual values and ranges therein, including UV-A (between about 320 and about 400 nm); UV-B (between about 280 and about 320 nm); and UV-C (between about 200 and about 280 nm). Other useful ranges include the radiation from visible, near-IR and IR lasers (about 500 nm to about 1.5 μm). Cleaving photoradiation is supplied using a variety of sources known in the art. As used herein, “latent fluorescent molecule” is a molecule where the conjugation has been disrupted by the attachment of a masking group, so that the fluorescence of the latent fluorescent molecule is lower than the fluorescence of the fluorescent molecule without the masking group attached. The fluorescence of a latent fluorescent molecule is increased when the photolabile covalent bond between the masking group and latent fluorescent molecule is broken. As used herein, “unmasked fluorescent molecule” is a fluorescent molecule from which a masking group has been released. As used herein, “fluorescence” includes phosphorescence. As used herein, “support” or “surface” indicates a material to which a molecule of the invention can be configured to attach. “Support” or “surface” does not necessarily indicate a substantially flat surface. The support or surface can have any of a number of shapes, such as strip, rod, particle, including bead, and the like. Examples of surfaces include conductive, semi-conductive, and non-conductive, including metal, silicon, ITO, glass and quartz. Conductive surfaces include metal surfaces and non-metal substrates with at least a partially electrically conductive layer or portion thereof attached thereto. Examples of electrically conductive materials include metals, such as copper, silver, gold, platinum, palladium, and aluminum; metal oxides, such as platinum oxide, palladium oxide, aluminum oxide, magnesium oxide, titanium oxide, tin oxide, indium tin oxide, molybdenum oxide, tungsten oxide, and ruthenium oxide; and electrically conductive polymeric materials, and mixtures thereof. For certain applications, an electrically conductive material can be deposited on or otherwise applied to a substrate to form a conductive surface. For example, an electrically conductive material can be deposited on a glass substrate or a silicon wafer or a plastic substrate to form a conductive surface. The substrate can be flexible. In other applications, the substrate is itself conductive such as a metal substrate. In some instances, a conductive layer can have a substantially uniform thickness and a substantially flat outer surface. In other instances, a conductive layer can have a variable thickness and a curved, stepped, or jagged outer surface. As used herein, “outer” means the side of the layer that is away from the substrate.

As used herein, “carbonyl group” contains the following structure:

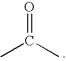

As used herein, a “dendrimer” is a structure formed from regular, highly branched monomers leading to a monodisperse, tree-like or generational structure. Dendrimers are built one monomer layer, or “generation,” at a time. A dendrimer comprises a multifunctional core molecule with a dendritic wedge attached to each functional site. The core molecule is referred to as “generation 0.” Each successive repeat unit along all branches forms the next generation, “generation 1,” “generation 2,” and so on until the terminating generation. An example of a dendrimer is the commercially available PAMAM dendrimer (Aldrich Chemical Co. As used herein, a “particle” is a discrete support that can be coated with a variety of materials, such as groups having functional groups allowing attachment of molecules. Examples of particles include commercially available particles such as TentaGel beads (Fluka Chemical Co.). As used herein, “liposome” is a fluid-filled structure whose walls are made of layers of phosopholipids. As used herein, “layer” does not necessarily indicate a complete monolayer is formed. There may be one or more gaps or defects in the layer, and there may be more than one monolayer with or without gaps or defects.

As used herein, “biological effector” is a molecule which is involved in any biological interaction, in vitro or in vivo, and which can be attached to a masked fluorescent molecule and/or masking group as described herein. Biological effectors includes proteins, peptides and nucleic acids and any small or large organic or inorganic molecules. One class of biological effectors includes those molecules having a carbonyl group or a nitrogen heterocycle which can hydrogen-bond to a nitrogen functionalities, for example, a NH (amide). As used herein, “molecule” refers to a collection of chemically bound atoms with a characteristic composition. As used herein, a molecule can be neutral or can be electrically charged. The term molecule includes biomolecules, which are molecules that are produced by an organism or are important to a living organism, including, but not limited to, proteins, peptides, lipids, DNA molecules, RNA molecules, oligonucleotides, carbohydrates, polysaccharides; glycoproteins, lipoproteins, sugars and derivatives, variants and complexes and labeled analogs of these. As used herein, “substantially” means more of the given structures have the listed property than do not have the listed property. As used herein, “about” is intended to indicate the value given is not necessarily exact, either as a result of the inherent uncertainty in measurement, or because the values surrounding the value given function in the same way as the value given. As used herein, “attach” refers to a coupling or joining of two or more chemical or physical elements. Examples of attachment includes chemical bonds such as chemisorptive bonds, covalent bonds, ionic bonds, van der Waals bonds, and hydrogen bonds. Various organic solvents and aqueous solutions, and mixtures thereof can be used in the reactions described herein, as known in the art. Additives such as buffers can be used as long as the additives do not prevent the desired reactions from occurring.

The photocleavage reaction can occur as a result of a single photon absorption or two photon absorption, as known in the art. The actual wavelength used for photocleavage depends on the UV/vis or near-IR absorption maximum of the masked fluorophore and is generally shorter than the absorption maximum for the unmasked fluorophore. This allows for monitoring the steady state fluorescence and at the same time irradiating with the wavelength causing fragmentation, conveniently avoiding “beam crossing” where the wavelength used to monitor the steady state fluorescence also causes fragmentation.

It is noted that derivatives of fluorescent molecules can be made that allow bonding of the desired masking group(s) in view of the disclosure herein and using methods of organic synthesis known in the art. These derivatives are apparent to one of ordinary skill in the art in view of the disclosure and these derivatives can be made using art known methods without undue experimentation. The formation of the photolabile covalent bond between the masking group and fluorescent molecule can be before, after, or during attachment of any portion thereof to a support. Unless otherwise specified, all groups described herein, including fluorescent molecules, masking groups, and unmasked fluorescent molecules can be optionally substituted with various groups, such as groups that allow attachment to another group, groups that allow attachment to a surface, allow alteration of the optical properties of the group, or groups that are present in commercially available analogues of groups or are as a result of synthesis methods used, as long as the substitution does not interfere with the desired use. Ring structures can be optionally substituted with one or more halogens, such as fluorine or chlorine, for example. Ring structures can also be substituted with one or more heteroatoms in the ring, for example. Other substituents can be added to various groups, such as alkyl groups, alkylene groups, alkenyl groups, alkenylene groups, alkynyl groups, alkynylene groups, aryl groups, arylene groups, iminyl groups, iminylene groups, hydride groups, halo groups, hydroxy groups, alkoxy groups, carboxy groups, thio groups, alkylthio groups, disulfide groups, cyano groups, nitro groups, amino groups, alkylamino groups, dialkylamino groups, silyl groups, and siloxy groups.

### BRIEF DESCRIPTION OF THE DRAWINGS

FIG. 1 shows fluorescence monitoring of the release from TentaGel beads.

FIG. 2 shows ketone 1d: (a) single- and two-photon LIF spectra exited at 355 nm (empty) and 532 nm (filled diamonds) respectively; (b) quadratic dependence of the LIF intensity on the power of the 532 nm laser pulses.

FIG. 3 shows the two-photon induced fragmentation of compound 2d at 532 nm.

### DETAILED DESCRIPTION OF THE INVENTION

The invention is further described by the following non-limiting description.

The general scheme describing the invention is shown below:

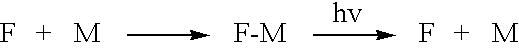

where F is a fluorescent molecule and M is a masking group. The masking group is bonded to the fluorescent molecule through a photolabile covalent bond which disrupts the conjugation of the fluorescent molecule, producing a masked fluorescent molecule. This disruption of the conjugation results in a shifting of the absorbance spectrum of the masked fluorescent molecule to shorter wavelengths than the fluorescent molecule. Cleaving photoradiation is applied to the masked fluorescent molecule, cleaving the photolabile covalent bond and reforming the fluorescence of the fluorescent molecule.

Substituents that are not involved in bonding the masking group to the fluorescent molecule may be attached to either or both of the fluorescent molecule or masking group and are useful for purposes such as adjusting the wavelength of fluorescence or absorbance or binding to a molecule of interest, for example a biological effector, and/or a support such as a dendrimer, particle, surface or liposome. Such substituents are known in the art and are generally shown as “X” or “Y” in the schemes below. The “X” and “Y” substituents may be the same or different and are attached using methods described herein and methods known to one of ordinary skill in the art without undue experimentation.

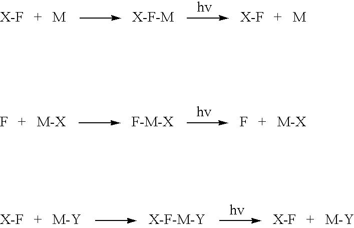

The unmasked fluorescent molecules may be monitored using techniques known in the art such as fluorescence microscopy or other types of spectroscopy, such as UV-vis absorption.

Fluorescent molecules which are useful in the invention include any molecule which has decreased fluorescence when one or more masking groups are attached, and increased fluorescence when at least one masking group is removed. Preferably, the molecule is non-fluorescent when one or more masking groups are attached and fluorescent when all the masking groups are removed. Fluorescent molecules useful in the invention contain, or can be modified to contain, at least one conjugated bond system that is disrupted by covalent bonding of the masking group(s).

A two photon process can also be used with the present invention. In a two photon process, radiation (such as laser radiation) in the near-IR or IR wavelength range is typically used for photocleavage. Absorption of two or more near-IR or IR photons having a combined energy equivalent to one UV photon pump the molecule to excited states. Use of a two photon process is useful when studying biological systems to minimize absorption of light by cells, and to minimize cell damage by higher energy radiation. The excitation volume for the two photon process is very small (typically a few femtoliters) because excitation is most probable only at the focal point of the focused laser beam. This provides additional spatial control for biological imaging experiments. Efficiency of two-photon photolysis is measured as the two-photon absorption cross section, as known in the art. Thioxanthones are examples of molecules having large two-photon absorption cross sections which are useful in the invention.

The photolabile molecules of the invention are especially useful in assays that require monitoring of fast dynamic processes in vivo or in vitro. Pulsed laser excitation allows for a high degree of temporal and spatial control. A high concentration of a biological effector or other molecular object of interest can be instantaneously created in a very small volume, and the dynamics of its distribution and localization in the surrounding medium can be monitored in real time by fluorescence microscopy or other spectroscopic techniques.

The intensity of the fluorescence from the fluorescent molecule provides information regarding the concentration of triggers present in the system. Attachment of a biological group of interest to the fluorescent molecule or masking group provides a method to monitor the biological group of interest in a variety of applications, as known in the art. Other applications of the invention are known and will be readily apparent to one of ordinary skill in the art in view of the disclosure provided herewith.

Several examples of molecules useful in the invention are included in Scheme 1, where structures 1a-f are fluorescent molecules and the remainder of the structures are masked fluorescent molecules. Molecules 2a-f are 2-methyldithiane adducts; molecules 3c, 3d are dithiane adducts; molecules 4c, 4d are dithiazine adducts and molecules 5a, 5c, and 5d are isobutyronitrile adducts.

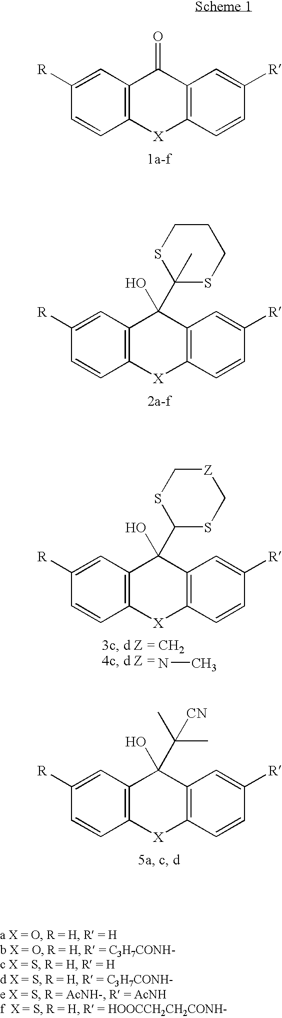

Some examples of useful masking groups are shown below:

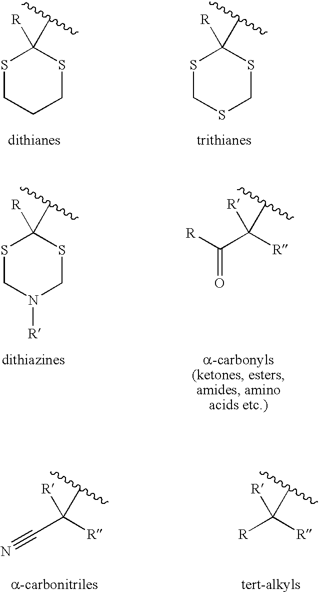

In the groups above, the wavy line indicates bonding to the remainder of the molecule, and the R, R′ and R″ substitutents may be the same or different. Exemplary R, R′ and R″ substituents include hydrogen, optionally-substituted straight chain, branched and cyclic C1-20 alkyl, alkenyl, or alkynyl groups where one or more of the C atoms can be substituted, or wherein one or more of the C, CH or CH₂ moieties can be replaced with O atoms, —CO— groups, —OCO— groups, N atoms, amine groups, S atoms or a ring structure, which ring structure can optionally contain one or more heteroatoms and which ring structure can be optionally substituted; and optionally substituted aromatic and nonaromatic ring structures, including rings that are fused to one or more other rings.

It is desired that the fluorescent molecules used in the invention have a high fluorescence quantum yield, preferably above 60-70%. One class of fluorescent molecules useful in the present invention include molecules useful as fluorescent dyes. One class of fluorescent dyes are those that contain a ketone functional group, such as fluorescein and fluorescein derivatives including fluorescein isothiocyanate derivatives; rhodamine and rhodamine derivatives including texas red and texas red derivatives; flavins and flavin derivatives; eosins and erythrosins; alizarin and alizarin derivatives; coumarin and coumarin derivatives; quinacrine and quinacrine derivatives. Another class of fluorescent dyes are those that do not contain a ketone functional group, and yet their conjugated system can be disrupted by addition to a double bond, for example, coumarine and coumarine derivatives, fluoresceine and other xanthene derivatives; and acridines and acridine derivatives.

Other examples of useful fluorescent molecules include those below:

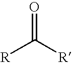

where at least one of R and R′ is a group which is conjugated with the carbonyl group and where R and R′ may be the same or different and are any useful groups, such as those disclosed herein. Examples of molecules having the structure above include:

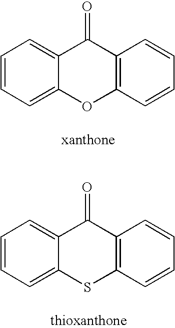

and substituted versions of the above, including those with heteroatoms in position 2. The photocleavage described herein does not require an external electron transfer sensitizer.

Characterization Experiments

Nucleophilic additions to the carbonyl groups of ketones 1a-f of Scheme 1 reduced their fluorescence by two orders of magnitude. The remaining p-amidodiphenyl sulfide moiety has tailing absorption well above 300 nm, allowing for photo deprotection in a wide spectral area. The relative quantum yield of fragmentation was highest for the 2-methyldithiane adducts 2. Adducts of dithiane (3), dithiazine (4) and isobutyronitrile (5) cleaved with about 30-60% relative quantum efficiency of the methyldithiane adducts.

Laser flash photolysis of 2d (355 nm Nd:YAG) showed a weak transient absorption band below 400 nm, which was assigned by analogy to the 2-amidothioxanthenol radical. The lifetime of these species was 1.7 μs and no further processes were detected, which puts an upper bound on the estimated time scale of this fragmentation.

Bulk photo reaction of 2d at 320 nm (0.49 mW cm⁻²) in acetonitrile solution was monitored by fluorescence of the product, i.e. ketone 1d. Within less then two minutes 90% conversion was achieved at this wavelength. Irradiation with the U-360 broad bandpass filter produced the same result in 10 min. Adduct 2d had very weak fluorescence; the overall emission at 458 nm had increased by more than two orders of magnitude.

### EXAMPLE OF IMMOBILIZATION TO A DENDRIMER OF TENTAGEL BEADS

As described above, the methods of the invention can be used to study the release of a biological effector. In this example, the fluorescent molecule is attached to a dendrimer, and the masking group is attached to the biological effector. Cleaving the photolabile covalent bond between the fluorescent molecule and the masking group produces fluorescence which reveals the initial location of the released biological effector and allows quantification of the concentration of the biological effector. One synthetic procedure is outlined in Scheme 2. 2-Aminothioxanthone 6 was acylated with glutaric anhydride and reacted with excess of a nucleophile (lithiated dithiane is used in this example) to furnish 2f, which was converted into the N-hydroxysuccinimide ester, 2f-NHS, and incubated in an orbital shaker with either 90 μm TentaGel-NH₂ beads or PAMAM-NH₂ dendrimer. According to NMR and elemental analysis, approximately 115 out of 128 surface amino groups of the fifth generation dendrimer were actually immobilized after 60 hour gentle shaking.

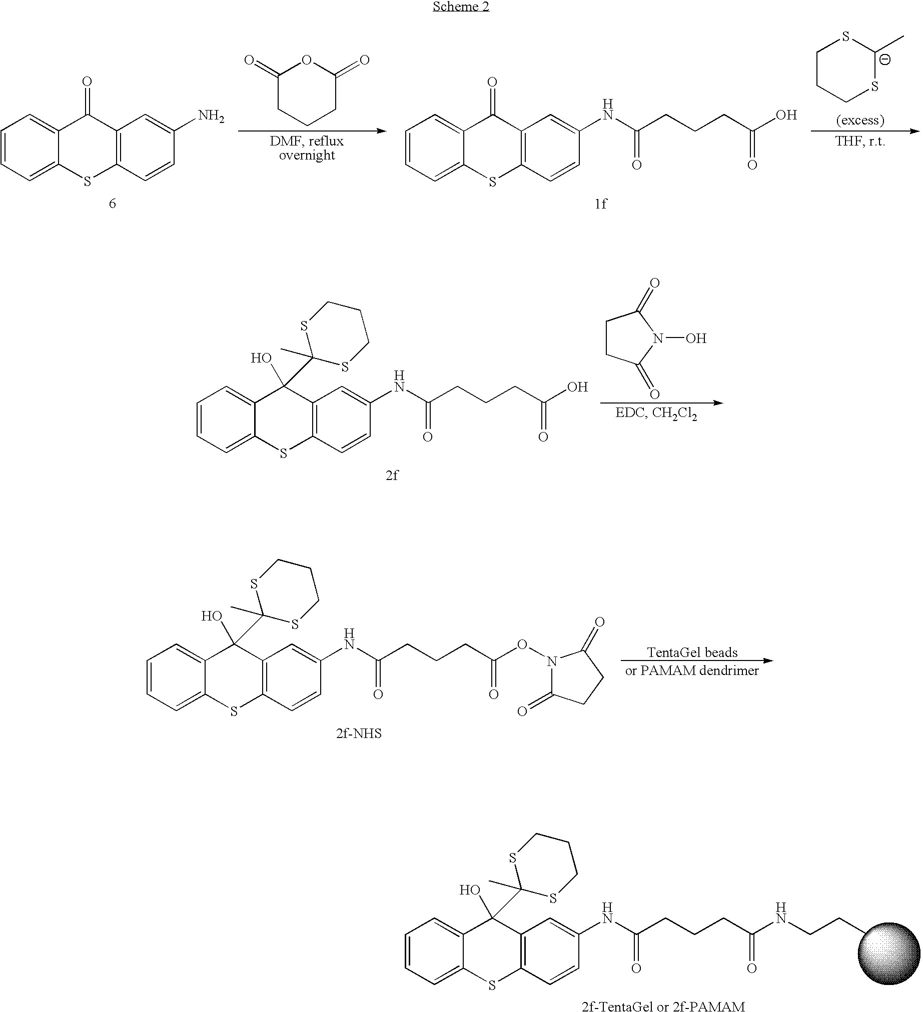

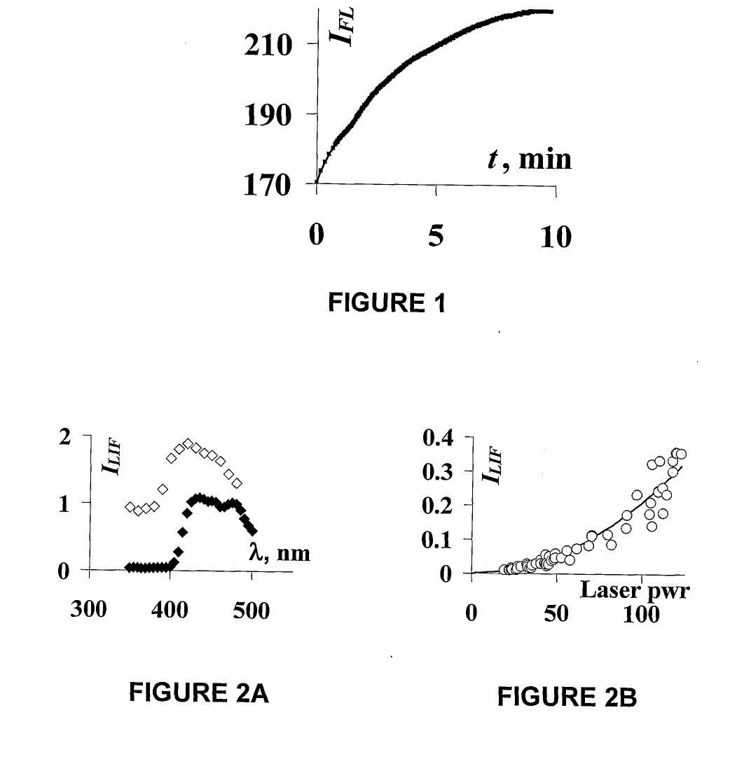

10 mg of the 2f-TentaGel beads were irradiated with a U-360 broadband filter and the total fluorescence was monitored (FIG. 1, arbitrary units). The resulting beads were mixed with the original 2f-TentaGel beads and the blank TentaGel beads as a control for comparison. In a comparison, using 405 nm excitation, the blank beads had a mean fluorescence intensity of 61.9, the original 2f-TentaGel beads had a mean fluorescence intensity of 78.3, and the irradiated beads had a mean fluorescence intensity of 111.0 (data not shown).

Irradiation of 2f-PAMAM produced a 17-fold increase in fluorescence intensity. Using multiple dilutions in glycerol (used to slow diffusion), a brightly lit dendrimer molecule was seen (data not shown). The calculated diffusion path in glycerol during 0.2 s ccd camera exposure time is 140 nm, which is in keeping with an observed approx. 200 nm bright inner spot in the fluorescent image. Stokes' hydrodynamic radius of the 1f-dendrimer is 3.2 nm as calculated from the PFG NMR diffusion coefficient of 3.42×10⁻⁷ cm²/s measured in DMSO-d₆. According to the Einstein equation, during the 200 ms exposure time of the CCD camera, the dendrimer of this size would travel about 9 μm in acetonitrile, which necessitated the use of a more viscous solvent, glycerol, for fluorescence imaging.

A complementary approach is to release the effector, tagged with 2-amidothioxanthone, for example, while immobilizing the radical leaving group (shown in Scheme 3). In an analogous process to that described above, photocleavage of the photolabile covalent bond produces biological effectors labeled with a fluorophore, allowing monitoring movement and accumulation/localization of the biological effectors.

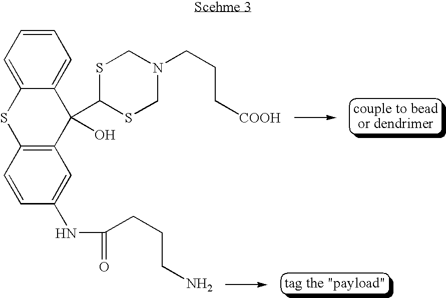

In the system discussed above, photoreleased fragments tagged by amidothioxanthone were monitored and quantified by two-photon fluorescence microscopy. Laser flash photolysis of ketone 1d at 532 nm showed strong laser induced fluorescence (LIF) with emission closely matching the spectrum generated at 355 nm, see FIG. 2a. The quadratic dependence of the LIF intensity on the relative laser power is shown in FIG. 2b. The two-photon induced fluorescence lifetime was also the same, approx. 4.5-4.8 ns.

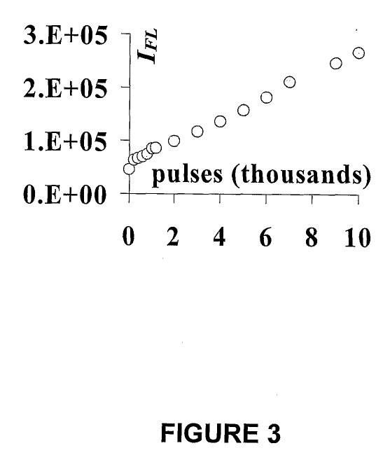

Adduct 2d itself possesses a considerable two-photon absorption cross section, allowing for the two-photon excitation to be used not only for fluorescence monitoring of the released ketone, but also to affect the actual photocleaving. FIG. 3 shows fragmentation of 2d, 1 mM solution in acetonitrile, being monitored by steady-state fluorescence of the generated ketone 1d as a function of laser pulses. After 10K shots fluorescence increased 5-fold.

Photo bleaching of the reporter ketone was tested with a 405 nm-filtered, focused output of a medium pressure mercury lamp (13 mW cm⁻², approx. 9.5×10¹⁹ photons per hour). After 4 hours continuous irradiation of the 10⁻⁴ M solution, fluorescence intensity decreased only by 7.1%.

Other modifications of the above system include using discrete oligomer supports having two, three, four or more attachment sites. Alternatively, a payload (e.g., biological effector) and support are linked through the photolabile bond between masking group and fluorescent molecule. In this embodiment, photocleavage of the photolabile bond disengages the carrier and support. A benzophenone adduct of “a tripod” oligomer having three dithiane molecules at the ends of its legs was synthesized:

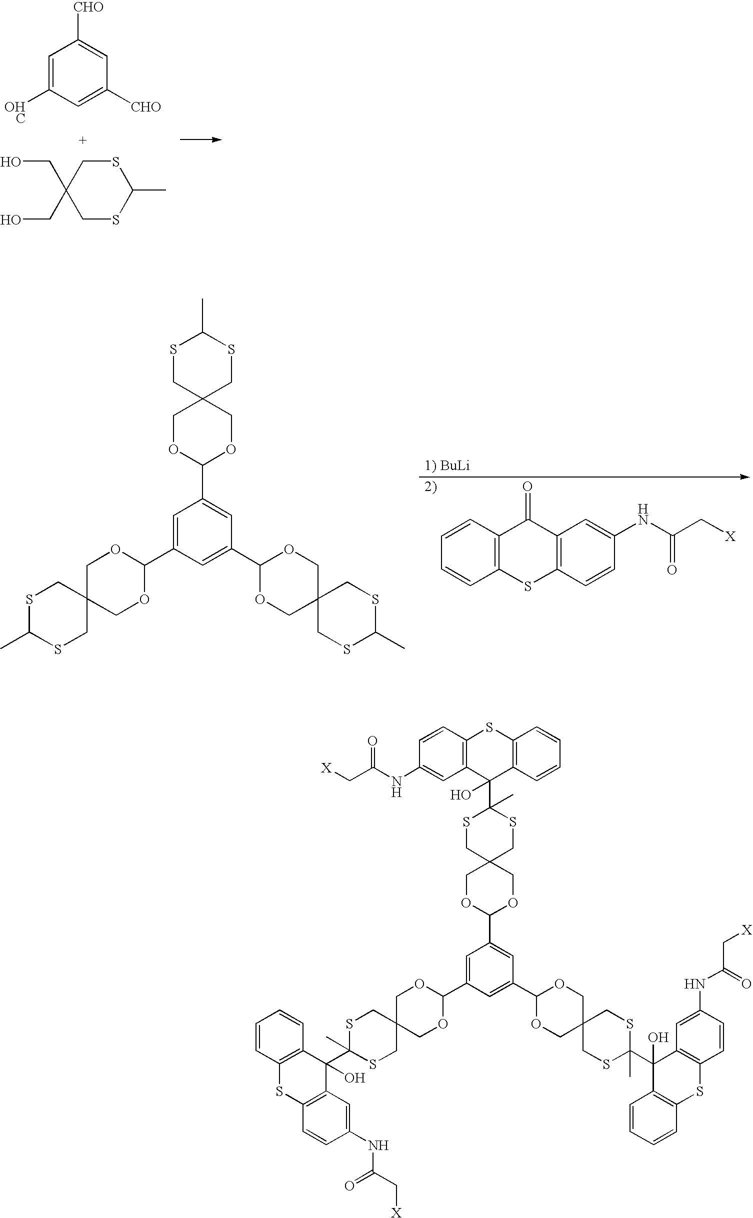

In this embodiment, three detachable groups (X) are tagged with masked fluorescent molecules that may be the same or different. If the masked fluorescent molecules are different, different wavelengths of cleaving photoradiation can be used to photocleave the photocleavable bond, giving a method to monitor multiple different events simultaneously.

### EXAMPLE OF SURFACE MODIFICATION

The methyldithiane adduct of 2-amidothioxanthone was immobilized on the self-assembled monolayer of 11-mercaptoundecanoic acid on gold (150 nm thin gold layer was thermally deposited on a 18 mm diameter microscope glass). It was estimated that about 1.7 nanomoles of the material was immobilized (Scheme 4). After photoinduced deprotection using a medium pressure 200 W mercury-xenon ozone-free lamp, an increase in fluorescence, concomitant with detection of methyldithiane in solution was observed. The fluorescence spectrum of the surface, obtained with a generic PMT at 1 kV and a grating monochromator was very similar to the fluorescence spectrum of 1d in free solution.

The strength of the signal attests to the feasibility of miniaturization and fabrication of chips for photoinduced drug release or release of biological effectors (linked via the dithiane moiety), with the possibility of instantaneous quantification.

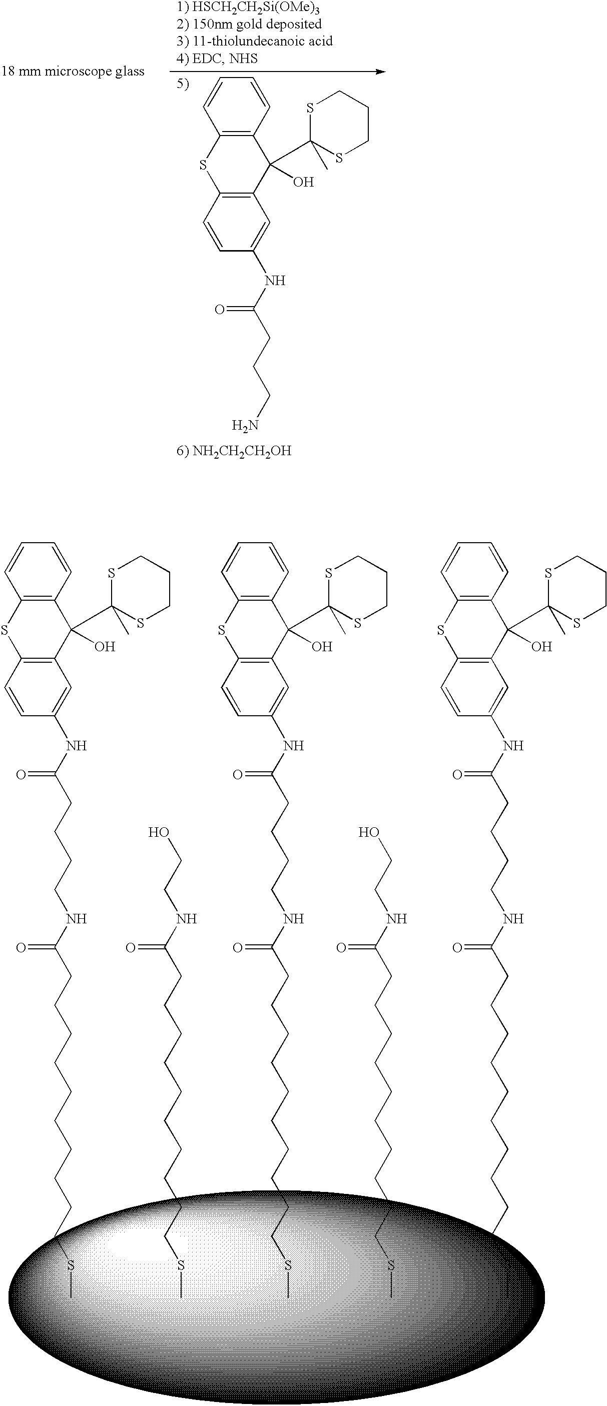

As with the previous examples, the fluorescent molecule can be permanently attached to the released molecule, while the masking group is attached to the surface. In this case the departing molecule (e.g. a biological effector) is released carrying the fluorescent tag for easy monitoring of the dynamics of its spatial distribution.

### EXAMPLE OF 2D OR 3D INFORMATION STORAGE

The masked fluorophore is embedded in a substantially transparent (for example, methyl acrylate or methacrylate) polymer, either by cross-polymerization or by dissolution of the masked fluorophore+ such polymer in an appropriate solvent, with subsequent evaporation of the solvent to form either a bulk transparent solid or a thin film. A focused laser beam of an appropriate wavelength, corresponding to the absorption of the masked fluorophore can then be used to “write” information in a form of fluorescing 2D or 3D dots. The reading of this information is done with a focused laser beam of a different wavelength, corresponding to the excitation of the free fluorophore. This mode is especially suitable for two photon writing and reading.

In this example, 2d was dissolved in a dichloromethane solution of poly methyl methacrylate (transparent down to 290 nm) and spin coated onto a glass slide to furnish a thin transparent film. The film was dried in vacuum, a non-transparent mask was applied and the film was irradiated with medium pressure mercury-xenon ozone-free lamp. Visual inspection of the film through a 458 nm narrow bandpass filter in the dark room under 365 nm excitation showed a clear fluorescent image of the mask.

Synthesis

Common reagents were purchased from the Sigma-Aldrich Chemical Co. and used without further purification. THF was refluxed over and distilled from potassium benzophenone ketyl prior to use. PAMAM dendrimer (5^{th} generation) was purchased from Aldrich Chemical Co. and TentaGel S—NH₂ beads were purchased from Fluka Chemical Co. The ¹H and ¹³C NMR spectra were recorded at 25° C. on a Varian Mercury 400 MHz instrument, CDCl₃, DMSO-d₆, CD₃OD and CD₃CN as solvents, and TMS was used as internal standard. The diffusion coefficients were measured with Varian Mercury's Performa I pulse field gradient module and 4 nucleus autoswitchable PFG probe. Elemental analyses were conducted at Huffman Laboratories Inc., Denver. Column chromatography was performed on Silica Gel, 70-230 mesh ASTM. UV-vis spectra were recorded on a Beckman DU-640 Spectrophotometer, and fluorescence spectra were recorded on SPEX-Fluorolog instrument and Hitachi, F-1050, Fluorescence Spectrophotometer. The irradiations were carried out in a carousel Rayonet photo reactor (RPR-3500 or RPR-3000 lamps), or with Oriel Photomax housing with a 200 W medium pressure ozone free mercury lamp and a grating monochromator or different wavelength bandpass filters, such as a U-360 nm broad bandpass (360 nm±45 nm) or 405 nm±5 nm narrow bandpass interference filter.

Synthetic Procedures:

N-(9-Oxo-9H-thioxanthene-2-yl)-butyramide:

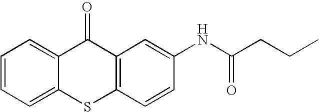

2-Aminothioxanthen-9-one (1 g, 4.4 mmol) was dissolved in 15 ml of dichloromethane, and butyryl chloride (0.7 g. 6.6 mmol) and cat. amount of triethyl amine was added to this solution under stirring. The reaction mixture was stirred at room temperature overnight. The resulting solid was filtered, washed with water, dried to furnish yellow powder (1.18 g, 90%).

¹H NMR (DMSO-d₆, 400 MHz): δ 10.25 (s, 1H), 8.71 (d, J=2.35 Hz, 1H), 8.45 (d, J=8.17 Hz, 1H), 8.04 (dd, J₁=2.36 Hz, J₂=8.76 Hz, 1H), 7.83-7.73 (m, 3H), 7.58-7.54 (m, 1H), 2.30 (t, J=7.28 Hz, 2H), 1.65-1.60 (m, 2H), 0.90 (t, J=7.35 Hz, 2H).

¹³C NMR (DMSO-d₆, 400 MHz): δ 179.31, 172.22, 138.91, 137.35, 133.49, 129.81, 129.47, 128.65, 127.75, 127.29, 127.22, 125.27, 118.65, 118.63, 39.02, 19.16, 14.31.

UV-Vis: λmax: 395 nm

Fluo: λex: 395 nm, λem: 460 nm, φ_{fluo}=0.646 (10⁻⁵M, Acetonitrile)

N-[9-Hydroxy-9-(2-methyl-[1,3]dithiane-2-yl)-9H-thioxanthene-2-yl]-butyramide:

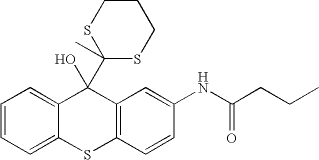

Methyldithiane (902 mg, 6.73 mmol) was dissolved in 15 mL of freshly distilled THF under nitrogen atmosphere. To this solution 2.52 mL of butyl lithium (1.6M solution in hexanes, 4 mmol) was added dropwise upon stirring at room temperature. The resulting mixture was stirred for 10 min at this temperature to generate the anion. N-(9-Oxo-9H-thioxanthene-2-yl)-butyramide, (400 mg, 1.35 mmol) in 10 mL of THF was added dropwise to the vigorously stirred solution of the methyldithianyl anion. The reaction mixture was stirred overnight at room temperature. The subsequent aqueous workup included quenching the reaction mixture with a 30 mL 1 M solution of ammonium chloride, extracting twice with ether, and drying the organic layer over sodium sulfate. The solvent was removed under vacuum, the crude reaction mixture was purified by silica gel column chromatography, hexane:EtOAc (9:1 & 3:2) as an eluent to afford pale yellow solid (380 mg, 65.2%).

¹H NMR (CDCl₃, 400 MHz): δ 8.03-8.02 (m, 2H), 7.72 (d, J=8.49 Hz, 1H), 7.35-7.26 (m, 4H), 4.03 (s, 1H), 2.91-2.86 (m, 2H), 2.73-2.66 (m, 2H), 2.27 (t, J=7.48 Hz, 2H), 1.91-1.86 (m, 4H), 1.74-1.64 (m, 2H), 1.49 (s, 3H), 0.95 (t, J=7.35 Hz, 3H).

¹³C NMR (CDCl₃, 400 MHz): δ 171.5, 135.51, 134.47, 133.34, 132.42, 130.67, 128.21, 127.43, 126.45, 125.91, 125.219, 121.84, 120.24, 80.20, 76.92, 62.42, 39.86, 27.86, 25.77, 24.58, 19.20, 13.99.

N-(9-[1,3]Dithan-2-yl-9-hydroxy-9H-thioxanthene-2-yl)-butyramide:

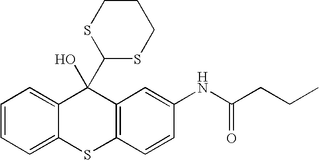

Dithiane (600 mg, 5 mmol) was dissolved in 15 mL of freshly distilled THF under nitrogen atmosphere, and 1.9 mL of butyl lithium (1.6M solution in hexanes, 3.03 mmol) was added to this solution dropwise upon stirring at room temperature. The resulting mixture was stirred for 10 min at this temperature to generate the anion. N-(9-Oxo-9H-thioxanthene-2-yl)-butyramide (300 mg, 1.01 mmol) in 10 mL of THF was added dropwise to the vigorously stirred solution of the dithiane anion. The reaction mixture was stirred overnight at room temperature. The subsequent aqueous workup included quenching the reaction mixture with a 30 mL 1 M solution of ammonium chloride, extracting twice with ether, and drying the organic layer over sodium sulfate. The solvent was removed under vacuum, the crude reaction mixture was purified by silica gel column chromatography, with hexane:EtOAc (9:1 & 3:2) as an eluent to afford pale yellow solid (300 mg, 71.8%).

¹H NMR (CDCl₃, 400 MHz): δ 7.85 (dd, J₁=1.57 Hz, J₂=7.70 Hz, 1H), 7.78 (d, J=8.29 Hz, 1H), 7.75 (d, J=2.26 Hz, 1H), 7.44 (dd, J₁=1.44 Hz, J₂=7.55 Hz, 1H), 7.38 (d, J=8.33 Hz, 1H), 7.36-7.26 (m, 2H), 7.22 (s, broad, 1H), 5.04 (s, 1H), 3.61 (s, broad, 1H), 2.81-2.68 (m, 2H), 2.67-2.61 (m, 2H), 2.30 (t, J=7.46 Hz, 2H), 1.98-1.93 (m, 1H), 1.79-1.68 (m, 3H), 0.98 (t, J=7.38 Hz, 3H).

¹³C NMR (CDCl₃, 400 MHz): δ 171.61, 138.29, 137.26, 136.75, 130.91, 127.99, 127.76, 127.23, 127.17, 126.22, 125.58, 119.77, 118.52, 77.9, 50.12, 39.84, 30.41, 30.33, 25.48, 19.18, 14.

N-[9-Hydroxy-9-(5-methyl-[1, 3, 5]dithiazinan-2-yl)-9H-thioxanthene-2-yl-butyramide:

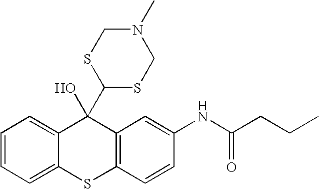

5-methyl-[1,3,5]dithiazine (909 mg, 6.72 mmol) was dissolved in 15 mL of freshly distilled THF under nitrogen atmosphere, and 2.6 mL of butyl lithium (1.6M solution in hexanes, 4.04 mmol) was added dropwise to this solution upon stirring at room temperature. The resulting mixture was stirred for 10 min at room temperature to generate the anion. N-(9-Oxo-9H-thioxanthene-2-yl)-butyramide (400 mg, 1.35 mmol) in 10 mL of THF was added dropwise to a vigorously stirred solution of the dithiazine anion. The reaction mixture was stirred overnight at room temperature. The subsequent aqueous workup included quenching the reaction mixture with a 30 mL 1 M solution of ammonium chloride, extracting twice with ether, and drying the organic layer over sodium sulfate. The solvent was removed under vacuum and the crude product was purified by silica gel column chromatography with hexane:EtOAc (9:1 & 1:1) as an eluent to afford yellow solid (320 mg, 54.9%).

¹H NMR (DMSO-d₆, 400 MHz): δ 10.01 (s, 1H), 7.94 (s, J=2.26 Hz, 1H), 7.77 (dd, J₁=1.37 Hz, J₂=7.84 Hz, 1H), 7.73 (dd, J₁=2.21 Hz, J₂=8.42 Hz, 1H), 7.40 (dd, J₁=1.27 Hz, J₂=7.56 Hz, 1H), 7.32-7.23 (m, 3H), 6.47 (s, 1H), 4.69 (s, 1H), 4.21 (d, J=13.24 Hz, 2H), 4.10 (d, J=11.69 Hz, 2H), 2.35 (s, 3H), 2.26 (t, J=7.31, 2H), 1.62-1.56 (m, 2H), 0.87 (t, J=7.34 Hz, 3H).

¹³C NMR (DMSO-d₆, 400 MHz): δ 171.82, 139.55, 138.72, 138.27, 130.46, 128.98, 128.01, 127.12, 126.90, 126.02, 123.47, 119.80, 118.94, 78.66, 60.20, 39.59, 38.97, 37.43, 19.27, 14.35, 14.32.

4-(9-Oxo-9H-thioxanthene-2-ylcarbamoyl)-butyric acid:

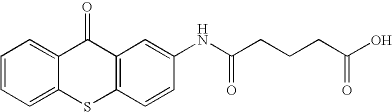

2-aminothioxanthen-9-one (0.6 g, 2.6 mmol) and glutaric anhydride (0.35 g, 2.9 mmol) were dissolved in 30 mL of DMF; the mixture was refluxed overnight, poured onto 200 g of crushed ice, resulting solid was filtered, thoroughly washed with dichloromethane and water, dried under vacuum to furnish yellow solid (620 mg, 71.6%).

¹H NMR (DMSO-d₆, 400 MHz): δ 12.05 (s, 1H), 10.28 (s, 1H), 8.71 (d, J=2.4 Hz, 1H), 8.44 (d, J=8.15 Hz, 1H), 8.01 (dd, J₁=2.41 Hz, J₂=8.72 Hz, 1H), 7.83-7.75 (m, 3H), 7.54 (m, 1H), 2.37 (t, J=7.29 Hz, 2H), 2.25 (t, J=7.24 Hz, 2H), 1.84-1.82 (m, 2H).

¹³C NMR (DMSO-d₆, 400 MHz): δ 179.26, 174.82, 171.81, 138.82, 137.32, 133.39, 130.87, 129.77, 129.41, 128.62, 127.69, 127.21, 127.14, 125.23, 118.65, 36.10, 33.65, 21.03.

4-(9-Oxo-9H-thioxanthene-2-ylcarbamoyl)-butyric acid 2,5-dioxopyrrolidin-1-yl-ester:

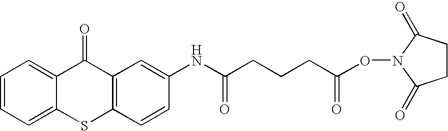

A mixture of 4-(9-Oxo-9H-thioxanthene-2-ylcarbamoyl)butyric acid (0.25 g, 0.73 mmol), N-hydroxy succinimide (126 mg, 1.1 mmol) and EDC (168 mg, 0.87 mmol) were dissolved in THF (20 mL)) and stirred for 24 hrs at room temperature. The resulting solid was filtered, washed with water and sat. aq. NaHCO₃, followed by 20 mL of brine; dried under vacuum to yield off yellow solid (260 mg, 81.25%).

¹H NMR (CDCl₃, 400 MHz): δ 10.36 (s, 1H), 8.9 (s, 1H), 8.44 (d, J=7.55 Hz, 1H), 8.02 (d, J=7.97 Hz, 1H), 7.83-7.75 (m, 3H), 7.54 (m, 1H), 2.83-2.75 (m, 6H), 2.52-2.45 (m, 2H), 1.99-1.92 (m, 2H)

4-[9-Hydroxy-9-(2-methyl-[1,3]-dithan-2-yl)-9H-thioxanthene-2-ylcarbamoyl]butyric acid:

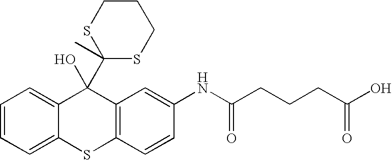

Methyldithiane (700 mg, 5.27 mmol) was dissolved in 10 ml of freshly distilled THF under nitrogen atmosphere, and 2.2 mL of butyl lithium (1.6M solution in hexanes, 3.51 mmol) was added dropwise with stirring at room temperature. After stirring for 10 min at r.t. to generate the anion, 4-(9-Oxo-9H-thioxanthene-2-ylcarbamoyl)butyric acid (300 mg, 0.87 mmol in 10 ml of THF) was added dropwise to the vigorously stirred solution of the dithiane anion. The reaction mixture was stirred overnight at room temperature. The subsequent aqueous workup included quenching the reaction mixture with a 30 mL 1 M solution of ammonium chloride, extracting twice with ether, and drying the organic layer over sodium sulfate. The solvent was removed under vacuum, the reaction mixture was purified by silica gel column chromatography, with hexane:EtOAc as an eluent (9:1 & 2:3) to give yellow solid (220 mg, 52.7%).

¹H NMR (CD₃OD, 400 MHz): δ 8.24 (d, J=2.25 Hz, 1H), 8.18-8.15 (m, 1H), 7.64 (dd, J₁=2.31 Hz, J₂=8.47 Hz, 1H), 7.27-7.21 (m, 4H), 3.33-3.28 (m, 2H), 2.60-2.55 (m, 2H), 2.44-2.37 (m, 4H), 2.02-1.94 (m, 3H), 1.84-1.74 (m, 1H), 1.24 (s, 3H).

¹³C NMR (CD₃OD, 400 MHz): δ 175.64, 172.59, 136.48, 135.74, 135.43, 131.94, 131.78, 127.41, 127.05, 124.94, 124.72, 124.38, 123.74, 119.99, 82.26, 59.43, 35.71, 32.94, 28.33, 25.076, 26.062, 24.40, 20.99

4-[9-Hydroxy-9-(2-methyl-[1,3]-dithan-2-yl)-9H-thioxanthene-2-ylcarbamoyl]butyric acid 2-methylene-5-oxo-pyrrolidin-1-yl-ester:

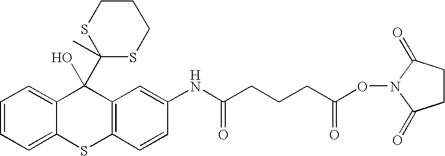

A mixture of 4-[9-Hydroxy-9-(2-methyl-[1,3]-dithan-2-yl)-9H-thioxanthene-2-ylcarbamoyl]butyric acid (170 mg, 0.35 mmol), N-hydroxysuccinimide (62 mg, 0.54 mmol) and EDC (75 mg, 0.39 mmol) was dissolved in DCM (20 mL) and stirred for 24 hrs at room temperature. After that it was washed with water, NaHCO₃, and brine; the organic layer was separated and dried over Na₂SO₄, solvent was removed under vacuum to afford a pale yellow solid (184 mg, 90%).

¹H NMR (CDCl₃, 400 MHz): δ 8.07-8.01 (m, 3H), 7.70 (dd, J₁=2.31 Hz, J₂=8.43 Hz, 1H), 7.33-7.26 (m, 4H), 3.93 (m, 1H), 2.93-2.85 (m, 6H), 2.73-2.67 (m, 4H), 2.41 (t, J=6.96 Hz, 2H), 2.21-2.13 (m, 2H), 1.92-1.82 (m, 2H), 1.5 (s, 3H).

¹³C NMR (DMSO-d₆, 400 MHz): δ 171, 170.92, 170.86, 169.47, 137.15, 136.82, 135.85, 132.67, 132.63, 128.14, 125.47, 125.31, 125.16, 124.96, 123.29, 119.57, 82.21, 60.24, 35.29, 30.34, 28.47, 28.36, 26.14, 25.88, 25.84, 24.64, 20.82.

4-(9-Oxo-9H-thioxanthene-2-ylcarbamoyl)-butyric acid-functionalized PAMAM-NH₂ Dendrimer (Generation 5):

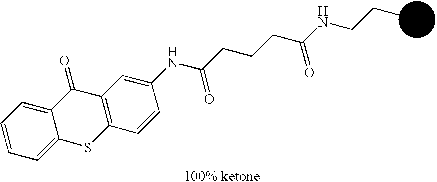

0.25 ml of a 5.5 wt % solution of the fifth generation PAMAM-NH₂ dendrimer in methyl alcohol was added to a 3 mL DCM solution of 4-(9-Oxo-9H-thioxanthene-2-ylcarbamoyl)butyric acid 2,5-dioxo-pyrrolidin-1-yl-ester (27 mg, 0.06 mmol) and the solution was stirred for 60 hrs. The solution was concentrated in vacuum, 20 mL of 1 N NaOH(aq) was added to this residue, and the suspension was stirred for 3 hrs. The suspension was filtered, and the solid was washed with 1 N NaOH(aq) and with distilled water. After being vacuum-dried, the product was obtained as yellow solid, 24 mg, 80%.

4-[9-Hydroxy-9-(2-methyl-[1,3]-dithan-2-yl)-9H-thioxanthene-2-ylcarbamoyl]butyric acid Functionalized PAMAM Dendrimer (Generation 5):

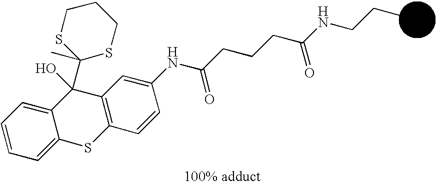

0.25 ml of a 5.5 wt % solution of the fifth generation PAMAM-NH₂ dendrimer in methyl alcohol was added to a 3 mL DCM solution of 4-[9-Hydroxy-9-(2-methyl-[1,3]-dithan-2-yl)-9H-thioxanthene-2-ylcarbamoyl]-butyric acid 2-methylene-5-oxopyrrolidin-1-yl-ester (37 mg, 0.06 mmol) and the solution was stirred for 60 h. The solution was concentrated in vacuum and stirred for 3 hrs with 20 mL of 1 N NaOH(aq). The suspension was filtered, and the solid was washed with 1 N NaOH(aq) and with distilled water. After being vacuum-dried, the product was obtained as yellow solid, 30 mg, 81%.

4-(9-Oxo-9H-thioxanthene-2-ylcarbamoyl)-butyric acid Functionalized TentaGel S—NH₂:

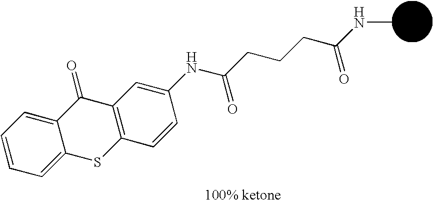

A mixture of the 90 μm TentaGel S—NH₂ beads (50 mg, 23 μmol) and 4-(9-Oxo-9H-thioxanthene-2-ylcarbamoyl)butyric acid 2,5-dioxp-pyrrolidin-1-yl-ester (9.8 mg, 23 μmol) in 2 mL of CH₂Cl₂ was shaken in an orbital shaker at room temperature for 24 hrs. The beads were washed with ethyl acetate (4×2 mL), acetonitrile (2×2 mL), shaken with acetonitrile (2 mL) for 1 hr, decanted, washed with acetonitrile several times, and dried under vacuum at 50° C. overnight to afford yellow beads.

4-[9-Hydroxy-9-(2-methyl-[1,3]-dithan-2-yl)-9H-thioxanthene-2-ylcarbamoyl]butyric acid Functionalized TentaGel S—NH₂:

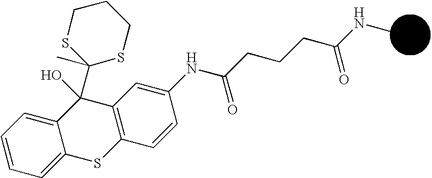

A mixture of TentaGel S—NH₂ (100 mg, 45 μmol) and 4-[9-Hydroxy-9-(2-methyl-[1, 3]-dithan-2-yl)-9H-thioxanthene-2-ylcarbamoyl]-butyric acid 2-methylene-5-oxo-pyrrolidin-1-yl-ester (26 mg, 45 μmol) in 2 mL of CH₂Cl₂ was shaken in a orbital shaker at room temperature for 24 hrs, washed with ethyl acetate (4×2 mL), acetonitrile (2×2 mL), shaken with acetonitrile (2 mL) for 1 hr, decanted, washed with acetonitrile several times, and dried under vacuum at 50° C. overnight to afford a pale yellow beads.

Determination of Quantum Yield of Fluorescence: Thioxanthone was used as a reference molecule for determining the quantum yield of fluorescence (φ_{flu}=0.12 in methanol). The quantum yield of Fluorescence was determined using the following equation.

φ_{f}=(Aₛ·Fᵤ/Fₛ·Aᵤ)×φₛ

where:

Aₛ=Absorbance of the standard

Aᵤ=Absorbance of the unknown

Fₛ=Emission intensity of the standard

Fᵤ=Emission intensity of the unknown

φₛ=quantum yield of the standard (0.12)

Fluorescence Microscopy

The images were obtained with a Zeiss Axiovert S100 inverted microscope equipped with a z-stepper motor, Sutter filter wheels and Cooke Sensicam CCD camera. The images were processed with Slidebook software (Intelligent Imaging Innovations, Denver, Colo.).

Laser Flash Photolysis

The system used: Applied Photophysics LKS.60/S Nanosecond Laser Photolysis Spectrometer with a digitizer from Agilent Technologies and a Laser System provided by OPOTEK.

One and two photon laser induced fluorescence of compound 1d show matching lifetimes. For single photon LIF: exited at 355 nm; emission @ 460 nm; lifetime is 4.8 ns For two photon LIF: exited at 532 nm; emission @ 460 nm; lifetime is 4.5 ns (data not shown).

Although the description herein contains many specificities, these should not be construed as limiting the scope of the invention, but as merely providing illustrations of some of the preferred embodiments of the invention. For example, fluorescent molecules, molecules of interest and masking groups other than those specifically exemplified herein may be used, as known to one of ordinary skill in the art without undue experimentation. Additional embodiments are within the scope of the invention and within the following claims. Chemical synthesis methods to attach masking groups to fluorescent molecules and molecules of interest to masking groups and/or fluorescent molecules are known to one of ordinary skill in the art. Other detection methods are known in the art. Additional embodiments are within the scope of the invention described in the specification and within the following exemplary claims.

When a group of substituents is disclosed herein, it is understood that all individual members of those groups and all subgroups, including any isomers and enantiomers of the group members, and classes of molecules that can be formed using the substituents are disclosed separately. When a molecule is claimed, it should be understood that molecules known in the art including the molecules disclosed in the references disclosed herein are not intended to be included. In particular, it should be understood that any molecule for which an enabling disclosure is provided in any reference cited in this specification is to be excluded from the claims herein if appropriate. When a Markush group or other grouping is used herein, all individual members of the group and all combinations and subcombinations possible of the group are intended to be individually included in the disclosure. Unless otherwise indicated, when a molecule is described and/or claimed herein, it is intended that any ionic forms of that molecule, particularly carboxylate anions and protonated forms of the molecule as well as any salts thereof are included in the disclosure. Counter anions for salts include among others halides, carboxylates, carboxylate derivatives, halogenated carboxylates, sulfates and phosphates. Counter cations include among others alkali metal cations, alkaline earth cations, and ammonium cations.

Every formulation or combination of components described or exemplified can be used to practice the invention, unless otherwise stated. Specific names of molecules are intended to be exemplary, as it is known that one of ordinary skill in the art can name the same molecules differently. When a molecule is described herein such that a particular isomer or enantiomer of the molecule is not specified, for example, in a formula or in a chemical name, that description is intended to include each isomer and enantiomer of the molecule described individually or in any combination. One of ordinary skill in the art will appreciate that methods, device elements, starting materials, synthetic methods, and detection methods other than those specifically exemplified can be employed in the practice of the invention without resort to undue experimentation. All art-known functional equivalents, of any such methods, starting materials, synthetic methods, and detection methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention. All photolabile systems known in the art to function in the identical method as those described herein are not intended to be included in this disclosure and should be construed as disclosed and not included individually and in combination.

In general the terms and phrases used herein have their art-recognized meaning, which can be found by reference to standard texts, journal references and contexts known to those skilled in the art. The specific definitions are provided to clarify their specific use in the context of the invention.

All patents and publications mentioned in the specification are indicative of the levels of skill of those skilled in the art to which the invention pertains.

One skilled in the art would readily appreciate that the present invention is well adapted to carry out the objects and obtain the ends and advantages mentioned, as well as those inherent therein. The molecules and methods and accessory methods described herein as presently representative of preferred embodiments are exemplary and are not intended as limitations on the scope of the invention. Changes therein and other uses will occur to those skilled in the art, which are encompassed within the spirit and scope of the invention.

All references cited herein are hereby incorporated by reference to the extent that there is no inconsistency with the disclosure of this specification. Some references provided herein are incorporated by reference herein to provide details concerning additional starting materials, additional methods of synthesis, additional methods of analysis and additional uses of the invention. U.S. provisional application 60/697,760, filed Jul. 8, 2005, from which this application claims priority, is incorporated by reference in its entirety.

### REFERENCES

Schoevaars, A. M.; Kruizing a, W.; Zijistra, R. W. J.; Veldman, N.; Spek, A. L.; Feringa, B. L. J. Org. Chem. 1997, 62, 4943.
Kurchan, A. N.; Kutateladze, A. G. Org. Lett., 2002, 4, 4129.

We claim:

1. A method of photofragmentation comprising:
providing a masked fluorescent molecule having a masking group bonded to a fluorescent molecule through a photolabile covalent bond which disrupts the conjugation of the fluorescent molecule;
exposing the masked fluorescent molecule to cleaving photoradiation, producing an unmasked fluorescent molecule;
detecting the fluorescence of the unmasked fluorescent molecule.

2. The method of claim 1, wherein either the unmasked fluorescent molecule or the masking group is attached to a molecule of interest.

3. The method of claim 2, wherein the molecule of interest is a biological effector.

4. The method of claim 1, wherein either the unmasked fluorescent molecule or the masking group is attached to a support.

5. The method of claim 3, wherein the support is a dendrimer, particle, surface or liposome.

6. The method of claim 1, wherein the photolabile covalent bond is formed by reaction of the masking group and a ketone group from the fluorescent molecule.

7. The method of claim 1, wherein the fluorescent molecule bonds to the masking group through a carbonyl group or a double bond.

8. The method of claim 1, wherein the masking group is selected from the group consisting of: dithiane, trithiane, dithiazine, tert-alkyl, nitrile, α-carbonyl, carboxamide and groups containing carbonyl-stabilized radical leaving groups.

9. The method of claim 1, wherein one of the unmasked fluorescent molecule and the masking group is attached to a support and the other of the unmasked fluorescent molecule and the masking group is attached to a molecule of interest.

10. The method of claim 9, wherein the support is a dendrimer, particle, surface or liposome.

11. The method of claim 10, wherein the surface is selected from the group consisting of: conductive, semi-conductive, and non-conductive, including metal, silicon, ITO, glass and quartz.

12. A photolabile molecule of formula:
F-M
wherein F is a latent fluorescent molecule;
M is a masking group which is bonded to the latent fluorescent molecule through a photolabile covalent bond which disrupts the conjugation of the fluorescent molecule.

13. The photolabile molecule of claim 12, wherein either F or M is attached to a molecule of interest.

14. The photolabile molecule of claim 13, wherein the molecule of interest is a biological effector.

15. The photolabile molecule of claim 12, wherein either F or M is attached to a support.

16. The photolabile molecule of claim 15, wherein the support is a dendrimer, surface or liposome.

17. The photolabile molecule of claim 12, wherein one of F or M is attached to a support and the other of F or M is attached to a molecule of interest.

18. The photolabile molecule of claim 12 wherein M is selected from the group consisting of: dithiane, trithiane, dithiazine, tert-alkyl, nitrile, carboxamide, α-carbonyl and groups containing carbonyl-stabilized radical leaving groups.

19. A plurality of molecules of claim 12 attached to a support.

20. A method of forming a plurality of support bound photolabile molecules, each molecule occupying a separate predefined region of the support, comprising:
a) binding a photolabile molecule of claim 12 to a first region of the support;
b) repeating step (a) on other predefined regions of the support, whereby each of the other regions has bound thereto another molecule of claim 12, and wherein each other molecule may be the same or different from that used in step (a).

21. The method of claim 20, further comprising:
c) exposing the photolabile molecule(s) to cleaving photoradiation, producing unmasked fluorescent molecule(s);
d) detecting the fluorescence of the unmasked fluorescent molecule(s).

22. The method of claim 20, wherein F is attached to the support and M is attached to a molecule of interest.

23. The method of claim 20, wherein M is attached to the support and F is attached to a molecule of interest.

24. The method of claim 20, wherein the support is a dendrimer, particle, surface or liposome.

25. The method of claim 24, wherein the surface is selected from the group consisting of: conductive, semi-conductive, and non-conductive, including metal, silicon, ITO, glass and quartz.
